(19) United States
(12) Patent Application Publication
(10) Pub. No.: US 2020/0005249 A1
(43) Pub. Date: Jan. 2, 2020

(54) MEETING SUPPORT SYSTEM, MEETING SUPPORT METHOD, AND STORAGE MEDIUM

(71) Applicant: HONDA MOTOR CO., LTD., Minato-ku, Tokyo (JP)

(72) Inventors: Tomoya Miyazaki, Tokyo (JP); Yuki Tanaka, Wako-shi (JP); Kenta Kawakami, Wako-shi (JP)

(21) Appl. No.: 16/491,591

(22) PCT Filed: Mar. 17, 2017
(86) PCT No.: PCT/JP2017/010851

§ 371 Date: Sep. 6, 2019

(51) Int. Cl. G06Q 10/10; H04W 4/029

(52) U.S. Cl. CPC G06Q 10/1095; H04W 4/029

(57) ABSTRACT

A meeting support system includes a movement means acquirer configured to acquire information related to a movement means of a first user, a movement means selector configured to select a movement means of a second user who meets with the first user on the basis of the information related to the movement means of the first user acquired by the movement means acquirer, and a provider configured to provide the movement means of the second user selected by the movement means selector to the second user.

### TECHNICAL FIELD

The present invention relates to a meeting support system, a meeting support method, and a storage medium.

### BACKGROUND ART

In the related art, there is a system that determines a meeting place, a time, or the like in consideration of an arrival time and a route of a meeting party. For example, there is a navigation system that estimates an arrival time from a movement trajectory of a user and determines a join position on the basis of an estimation result and the like when determining the join position between the user who moves using a public movement means and a vehicle (for example, refer to Patent Literature 1). In addition, there is a meeting support system that determines a plurality of meeting candidate sites on the basis of a degree of difficulty of a route, provides a plurality of routes generated for each meeting candidate site to the user, and specifies a meeting candidate site selected by the user as a meeting place (for example, refer to Patent Literature 2).

### CITATION LIST

### Patent Literature

Patent Literature 1

Japanese Unexamined Patent Application, First Publication No. 2010-185713

### Patent Literature 2

Japanese Unexamined Patent Application, First Publication No. 2013-096923

### SUMMARY OF INVENTION

### Technical Problem

However, in the related art, even in a case in which they join depending on the movement means of the user who meets, a case in which it is necessary to leave the movement means of the user at the meeting place, a case in which it is necessary to park the movement means (vehicle) at a distant position, or the like is required to occur. As a result, it is difficult to adjust the meeting place, there is a case in which the user may feel inconvenient related to the meeting, and there is a concern that an opportunity for users to meet may be reduced.

The present invention has been made in consideration of such circumstances, and an object of the present invention to provide a meeting support system, a meeting support method, and a program for supporting comfortable meeting.

### Solution to Problem

(1): A meeting support system includes a movement means acquirer configured to acquire information related to a movement means of a first user, a movement means selector configured to select a movement means of a second user who meets with the first user on the basis of the information related to the movement means of the first user acquired by the movement means acquirer, and a provider configured to provide the movement means of the second user selected by the movement means selector to the second user.

(2): The meeting support system according to (1), a meeting place determiner configured to determine a meeting place according to each movement means on the basis of the movement means of the first user acquired by the movement means acquirer and the movement means of the second user acquired by the movement means selector is further be included.

(3): The meeting support system according to (1), the movement means selector selects the movement means of the second user on the basis of a movement plan after the first user and the second user meet.

(4): The meeting support system according to (1), the movement means acquirer estimates the movement means of the first user on the basis of a movement trajectory of position information of the first user.

(5): The meeting support system according to (1), in a case in which the first user goes to a meeting place by walking or one other than his or her own movement means, the movement means selector selects a movement means capable of getting on the first user among movement means available to the second user, and in a case in which the first user goes to the meeting place by his or her own movement means, the movement means selector selects a movement capable of getting on both of the first user and the movement means of the first user among the movement means available to the second user.

(6): The meeting support system according to (1), in a case in which there is no movement means capable of getting on the movement means of the first user acquired by the movement means acquirer among the movement means available to the second user, the provider provides information for requesting not to go to a meeting by the movement means of the first user to the first user.

(7): The meeting support system according to (1), in a case in which the first user goes to a meeting place by the movement means capable of getting on both of the second user and the movement means of the second user, the movement means selector selects the movement means of the second user among the movement means available to the second user, and in a case in which the first user goes to the meeting place by one other than the movement means capable of getting on both of the second user and the movement means of the second user, the movement means selector selects walking or one other than his or her own movement means as the movement means of the second user.

(8): The meeting support system according to (1), the first user and the second user are one of a user who takes advantage of a movement means or a user who provides the movement means, and the movement means selector acquires the movement means of the second user on the basis of the number of the first users and the number of the second users who meet.

(9): A meeting support method causes a computer to acquire information related to a movement means of a first user, select a movement means of a second user who meets with the first user on the basis of the acquired information related to the movement means of the first user, and provide the selected movement means of the second user to the second user.

(10): A computer-readable non-transitory storage medium storing a program causes a computer to acquire information related to a movement means of a first user, select a movement means of a second user who meets with the first user on the basis of the acquired information related to the movement means of the first user, and provide the selected movement means of the second user to the second user.

### Advantageous Effects of Invention

According to (1), (9), and (10), it is possible to allow the second user to meet with the first user by the movement means according to the movement means of the first user.

According to (2), it is possible to realize a smooth getting on a vehicle at the meeting place.

According to (5), it is also possible to allow the first user to meet with the second user by the movement means according to the movement means of the second user.

According to (7), the second user is able to go to the meeting place by the movement means according to the number of people who meet.

### BRIEF DESCRIPTION OF DRAWINGS

FIG. 1 is a schematic diagram of a meeting support system.

FIG. 2 is a diagram showing a functional constitution of a first terminal device 10.

FIG. 3 is a diagram showing an example of a schedule input screen.

FIG. 4 is a diagram showing an example of a meeting notification screen.

FIG. 5 is a diagram showing a functional constitution of a meeting support device.

FIG. 6 is a diagram showing an example of a content of user position information.

FIG. 7 is a diagram showing an example of a content of schedule information.

FIG. 8 is a diagram showing an example of a content of user attribute information.

FIG. 9 is a diagram showing an example of a content of movement means information.

FIG. 10 is a sequence diagram showing a process executed in the meeting support system.

FIG. 11 is a flowchart showing a process executed in the meeting support device.

### DESCRIPTION OF EMBODIMENTS

Hereinafter, an embodiment of a meeting support system, and a meeting support method according to the present invention will be described with reference to the drawings.

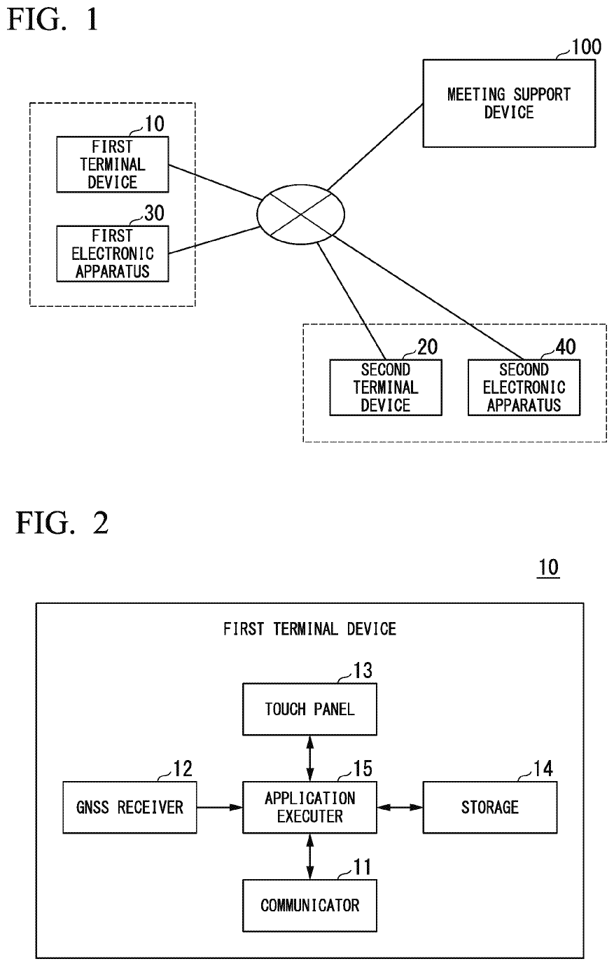

FIG. 1 is a schematic diagram of a meeting support system 1. As shown in FIG. 1, the meeting support system 1 includes a first terminal device 10, a second terminal device 20, a first electronic apparatus 30, a second electronic apparatus 40, and a meeting support device 100 that communicate with each other using a network NW. The network NW includes, for example, some or all of a wide area network (WAN), a local area network (LAN), the Internet, a provider device, a wireless base station, a dedicated line, and the like.

A target of support by the meeting support system 1 is, for example, a meeting such as a taking advantage of one movement means by the other from joining. The movement means includes walking, bicycles, motorbikes, automobiles (car types, vehicle types), taxis, trains, and the like. In the present embodiment, a user who provides the movement means will be described as a second user, and a user taking advantage of the movement means of the second user will be described as a first user. However, the present invention is not limited thereto, and a relationship between the first user and the second user may be reversed. In addition, the number of people included in the first user and the second user may be singular or plural.

The first terminal device 10 is a terminal device possessed by a first user, and the second terminal device 20 is a terminal device possessed by a second user. The first terminal device 10 and the second terminal device 20 are terminals operated by the user, and are, for example, a desktop computer, a notebook computer, a personal digital assistant (PDA), a smartphone or a tablet terminal.

The first electronic apparatus 30 is various electronic apparatuses existing in a life space of the first user, and the second electronic apparatus 40 is various electronic apparatuses existing in a life space of the second user. The first electronic apparatus 30 and the second electronic apparatus 40 include, for example, at least one of a television, a refrigerator, a camera, a sensor, an electric meter, an interactive robot, a generator, a wearable terminal, an in-vehicle device, and the like. The first electronic apparatus 30 and the second electronic apparatus 40 acquire life information, and transmit the acquired life information to the meeting support device 100 at a predetermined timing.

The life information is information related to a life of the user, and includes, for example, browsing history information of a television, information indicating a content of a refrigerator, information indicating a time zone, a destination, or the like where a vehicle on which an in-vehicle device is mounted travels, and an age, a gender, or the like of the user registered in advance.

Next, a functional constitution of the first terminal device 10 will be described with reference to FIG. 2. FIG. 2 is a diagram showing the functional constitution of the first terminal device 10. As shown in FIG. 2, the first terminal device 10 includes a communicator 11, a GNSS receiver 12, a touch panel 13, a storage 14, and an application executer 15.

The communicator 11 has hardware for connecting to the network NW using a cellular network, a Wi-Fi network, or the like. For example, the communicator 11 includes an antenna, a transmission/reception device, and the like. The communicator 11 communicates with the meeting support device 100 through the network NW, transmits various pieces of information, acquires various pieces of information from the meeting support device 100, and outputs the various pieces of information to the application executer 15.

The global navigation satellite system (GNSS) receiver 12 specifies a position of the first user who possesses the first terminal device 10 on the basis of a signal received from a satellite constituting a global positioning system such as GLONASS, Galileo, or the like.

The touch panel 13 is formed integrally with a touch pad type input unit and a display. The display is a liquid crystal display (LCD), an organic electroluminescence (EL) display, or the like. Note that the first terminal device 10 is not limited thereto, and may include, for example, some or all of various keys, buttons, dial switches, a mouse, and the like as an input unit.

The storage 14 stores, for example, an application program downloaded from the meeting support device 100.

The application executer 15 is realized, for example, by a processor such as a central processing unit (CPU) executing an application program. The application executer 15 causes the touch panel 13 to display a predetermined operation screen, and transmits information input on the screen to the meeting support device 100 using the communicator 11. In addition, the application executer 15 generates a predetermined screen on the basis of information received from the meeting support device 100 and causes the touch panel 13 to display the screen. In addition, the application executer 15 periodically transmits position information acquired by the GNSS receiver 12 to the meeting support device 100 using the communicator 11.

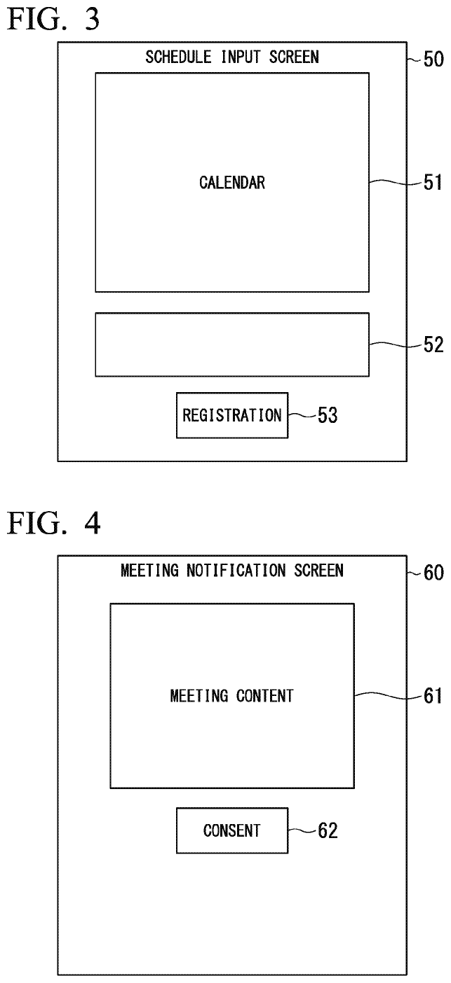

Next, an example of the operation screen displayed on the touch panel 13 will be described with reference to FIGS. 3 and 4.

FIG. 3 is a diagram showing an example of a schedule input screen. As shown in FIG. 3, the schedule input screen 50 includes, for example, a calendar 51, an input field 52, and a registration button 53. The input field 52 receives an input of a schedule for a date designated in the calendar 51. The registration button 53 is an operation button for receiving a registration instruction. In a case in which the registration button 53 is touched, the application executer 15 creates information in which information input to the input field 52 is associated with the designated date (hereinafter referred to as schedule information), and transmits the schedule information to the meeting support device 100 using the communicator 11. The schedule information includes information indicating a schedule input to a calendar on electronic data, information indicating a schedule described on a memo pad on electronic data, and the like.

FIG. 4 is a diagram showing an example of a meeting notification screen. As shown in FIG. 4, the meeting notification screen 60 includes, for example, a meeting content 61 and a consent button 62. Information related to the meeting acquired by the meeting support device 100 is displayed on the meeting content 61. The consent button 62 is an operation button for receiving a consent instruction related to the content of the meeting. In a case in which the consent button 62 is touched, the application executer 15 transmits consent information indicating the consent of the meeting with the content indicated by the meeting content 61 to the meeting support device 100 using the communicator 11.

The second terminal device 20 also has the same constitution and function as the first terminal device 10. Therefore, the detailed description is omitted.

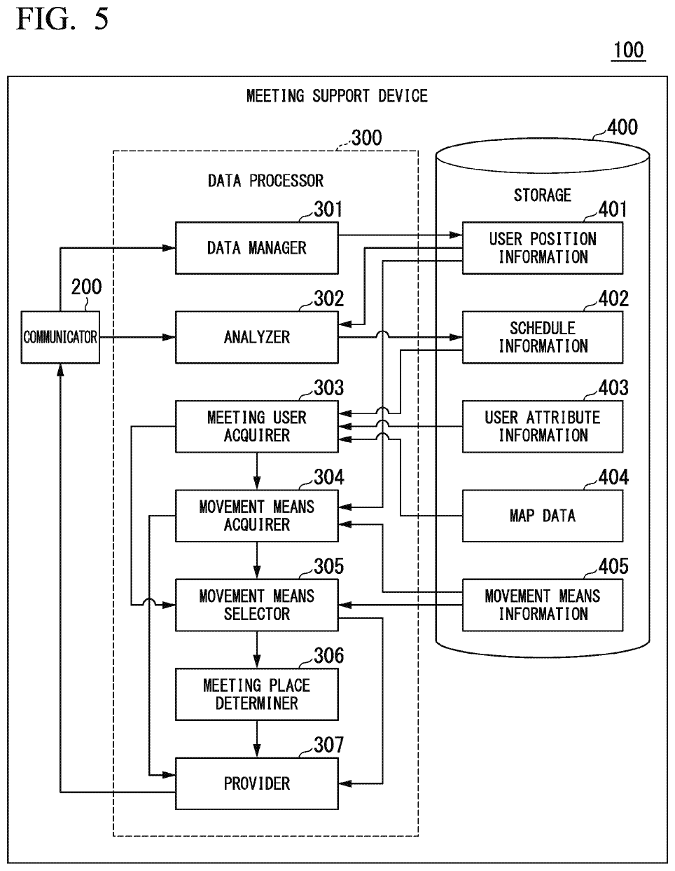

Next, a functional constitution of the meeting support device 100 will be described with reference to FIG. 5. FIG. 5 is a diagram showing the functional constitution of the meeting support device 100. As shown in FIG. 5, the meeting support device 100 includes a communicator 200, a data processor 300, and a storage 400.

The communicator 200 communicates with the first terminal device 10, the second terminal device 20, the first electronic apparatus 30, and the second electronic apparatus 40, for example, through the network NW. The communicator 200 outputs various pieces of information acquired from the first terminal device 10, the second terminal device 20, the first electronic apparatus 30, and the second electronic apparatus 40 to the data processor 300.

The constitution elements of the data processor 300 are realized, for example, by a processor such as a central processing unit (CPU) executing a program (software) stored in the storage 400. In addition, some or all of the constitution elements of the data processor 300 may be realized by hardware such as a large scale integration (LSI), an application specific integrated circuit (ASIC), or a field-programmable gate array (FPGA), and may be realized by cooperation of software and hardware. The data processor 300 includes a data manager 301, an analyzer 302, a meeting user acquirer 303, a movement means acquirer 304, a movement means selector 305, a meeting place determiner 306, and a provider 307.

The data manager 301 stores various pieces of information acquired using the communicator 200 in the storage 400. For example, the data manager 301 stores the position information received from the first terminal device 10 and the position information received from the second terminal device 20 in position information 401. In addition, the data manager 301 transmits various pieces of information and the like read from the storage 400 to the first terminal device 10 and the second terminal device 20 through the communicator 200 and the network NW.

The analyzer 302 analyzes an action of the first user on the basis of the life information received from the first terminal device 10. In addition, the analyzer 302 analyzes an action of the second user on the basis of the life information received from the second terminal device 20. For example, the analyzer 302 acquires an action pattern of the user by the analysis, and estimates a timing of an action such as a timing of going to shopping, a timing of going to a beauty salon, a timing of going to a hospital. The analyzer 302 stores an analysis result in schedule information 402.

Note that the analyzer 302 may analyze the action of the first user on the basis of the schedule information received from the first terminal device 10, and may analyze the action of the second user on the basis of the schedule information received from the second terminal device 20.

The meeting user acquirer 303 acquires information related to a user of which a schedule of the meeting is determined (hereinafter referred to as a meeting user) on the basis of the schedule information 402.

The meeting user acquirer 303 determines a meeting user as the first user or the second user on the basis of a schedule, a relationship, and the like of the meeting user. For example, among the meeting users, the meeting user acquirer 303 determines a user who is to use walking or a public movement means as the first user on the schedule of a day on which the meeting is performed and determines a user who is to use his or her own movement means on the schedule of a day on which the meeting is performed as the second user. In addition, the meeting user acquirer 303 may determine the first user and the second user on the basis of the relationship of the meeting users. For example, in a case in which the relationship between the users corresponding to a meeting target is a parent-child relation and an age of the parents is a specific age (for example, 60 or more), the meeting user acquirer 303 may determine the parents as the first user and may determine the child as the second user. In a case in which an age of the child is a specific age (for example, 20 or less), the meeting user acquirer 303 may determine the child as the first user and may determine the parents as the second user. In addition, among the meeting users, the meeting user acquirer 303 may determine a user who does not possess the movement means as the first user and may determine a user who possesses the movement means as the second user.

The meeting user acquirer 303 generates information related to meeting between the meeting users. For example, the meeting user acquirer 303 refers to map data 404 and, generates information including a candidate site of the meeting place, time zone, or the like (hereinafter, referred to as a meeting candidate information) on the basis of schedule information and the current position of the first user and the second user. The meeting user acquirer 303 outputs the created meeting candidate information to the movement means acquirer 304 and the movement means selector 305. The meeting user acquirer 303 may include the number of people included in the first user and the number of people included in the second user in the meeting candidate information.

The movement means acquirer 304 acquires the movement means of the first user. For example, the movement means acquirer 304 refers to the user position information 401 and estimates the movement means on the basis of a movement trajectory of the first user. In addition, the movement means acquirer 304 may refer to the schedule information 402 and estimate the movement means of the first user on the basis of the schedule of the first user. Note that, in a case in which the meeting place is a home of the first user or a stay destination such as a hotel, the movement means acquirer 304 may acquire that there is no movement means.

The movement means selector 305 selects the movement means of the second user on the basis of the movement means of the first user acquired by the movement means acquirer 304. For example, in a case in which the first user goes to the meeting place by walking or one other than his or her own movement means (for example, a public movement means or other transferal means), the movement means selector 305 selects a movement means on which the first user is able to get among the movement means available to the second user. On the other hand, in a case in which the first user goes to the meeting place by his or her own movement means, the movement means selector 305 selects the movement means on which the first user and the movement means of the first user are able to get among the movement means available to the second user. Note that, in a case in which the meeting place is a home of the second user or a stay destination such as a hotel, the movement means selector 305 may select that there is no movement means.

Note that, in a case in which there is no movement means on which the movement means of the first user acquired by the movement means acquirer 304 is able to be loaded among the movement means available to the second user, the movement means selector 305 may generate information for requesting the first user to go to the meeting place by one other than the movement means of the first user and output the information to the provider 307.

The meeting place determiner 306 determines the meeting place and the meeting time according to mutual movement means on the basis of the movement means of the first user acquired by the movement means acquirer 304 and the movement means of the second user selected by the movement means selector 305. For example, the meeting place determiner 306 refers to the map data 404, searches for a place closest to the meeting candidate site, at which the movement means of the second user is temporarily parked and it is possible to join with the first user, on the basis of the meeting candidate information generated by the meeting user acquirer 303, and determines the place obtained by the search as the meeting place. In addition, in a case in which it is necessary to load the movement means of the first user on the movement means of the second user, the meeting place determiner 306 may determine a place where this work is possible as the meeting place.

In addition, the meeting place determiner 306 refers to the user position information 401 or the schedule information 402 and determines the meeting time. For example, the meeting place determiner 306 determines a time when it is possible to arrive at the meeting place as the meeting time on the basis of the schedule information 402 of each user. In addition, the meeting place determiner 306 may derive the time of arrival at the meeting place on the basis of the movement trajectory of each user and determine a later time as an arrival time.

In a case in which the meeting place determiner 306 determines the meeting place and the meeting time, the provider 307 provides the movement means of the first user acquired by the movement means acquirer 304 and the movement means of the second user selected by the movement means selector 305 to the first user and the second user together with the meeting place and the meeting time. The provider 307 may transmit the information to be provided to the user to the first terminal device 10 and the second terminal device 20, or may transmit the information to be provided to the user to the first electronic apparatus 30 or the second electronic apparatus 40.

The storage 400 is realized by, for example, a random access memory (RAM), a read only memory (ROM), a flash memory such as a solid state drive (SSD), a hard disk drive (HDD), or the like. The storage 400 stores information such as the user position information 401, the schedule information 402, the user attribute information 403, the map data 404, and the movement means information 405.

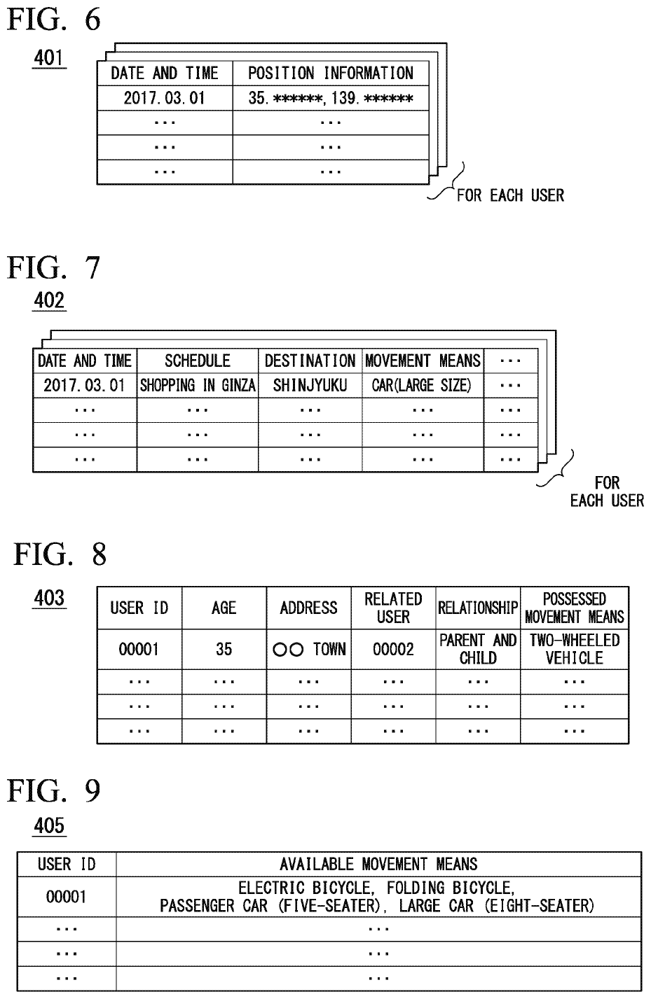

The user position information 401 is the position information indicating the position of each user. FIG. 6 is a diagram showing an example of a content of the user position information 401. As shown in FIG. 6, for example, the user position information 401 is stored in the storage 400 in a form of a table in which information indicating date and time and position information are associated with each other. Note that the table in which the information indicating date and time the position information are associated with each other is prepared for each user and is associated with unique information for identifying each user (hereinafter, referred to as a user ID).

The schedule information 402 is information indicating the schedule of each user. FIG. 7 is a diagram showing an example of a content of the schedule information 402. As shown in FIG. 7, for example, the schedule information 402 is stored in the storage 400 in a form of a table in which information indicating date and time and the schedule information are associated with each other. The schedule information includes, for example, information in which contents of the schedule are classified into items, such as a schedule, a destination, and a movement means. In each item of the schedule information, information registered by the user or the action of the user obtained by the analysis by the analyzer 302 is stored. Note that the table in which the information indicating date and time and the schedule information are associated with each other is prepared for each user and is associated with the user ID.

The user attribute information 403 is information indicating an attribute of the user. FIG. 8 is a diagram showing an example of a content of the user attribute information 403. As shown in FIG. 8, for example, the user attribute information 403 is stored in the storage 400 in a form of a table in which information such as an age, an address, a user ID of a related user, a relationship with a related user, and a possessed movement means are associated with the user ID. The related user is a user having a predetermined relationship with the user indicated in the item of the user ID.

The map data 404 includes, for example, road information in which a road is expressed as a link, information of the width and curvature of each link, road shape information in the vicinity of an intersection or a station, and point of interest (POI) information.

The movement means information 405 is information indicating the movement means available to the user. FIG. 9 is a diagram showing an example of a content of the movement means information 405. As shown in FIG. 9, for example, the movement means information 405 is stored in the storage 400 in a form of a table in which an available movement means are associated with the user ID.

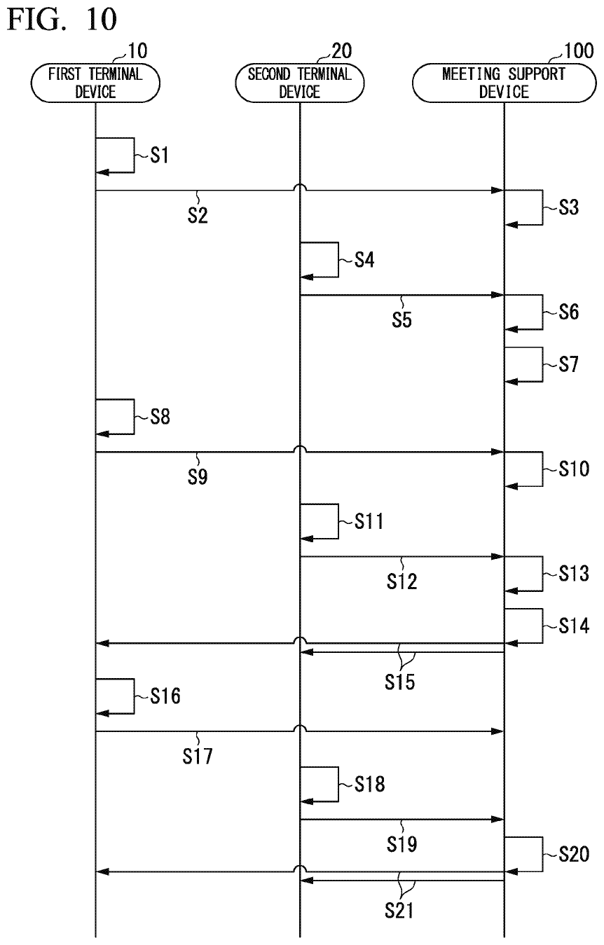

Next, a process executed in the meeting support system 1 will be described with reference to FIG. 10. FIG. 10 is a sequence diagram showing the process executed in the meeting support system 1. Note that illustration of processes by the first electronic apparatus 30 and the second electronic apparatus 40 is omitted.

First, the first terminal device 10 receives the input of the schedule information using the touch panel 13 (step S1), and transmits the received schedule information to the meeting support device 100 using the communicator 11 (step S2). The meeting support device 100 stores the received schedule information in the schedule information 402 of the storage 400 (step S3).

Similarly, the second terminal device 20 also receives the schedule information (step S4), and transmits the received schedule information to the meeting support device 100 (step S5). The meeting support device 100 stores the received schedule information in the schedule information 402 of the storage 400 (step S6).

Note that, although illustration is omitted, the first electronic apparatus 30 and the second electronic apparatus 40 transmit the acquired life information to the meeting support device 100. The meeting support device 100 analyzes the action of the user on the basis of the received life information, and stores the analysis result in the schedule information 402 of the storage 400 (step S7).

The first terminal device 10 specifies the position of the first user using the GNSS receiver 12 (step S8), and transmits the position information indicating the specified position of the first user to the meeting support device 100 using the communicator 11 (step S9). The meeting support device 100 stores the received position information in the user position information 401 of the storage 400 (step S10).

Similarly, the second terminal device 20 also specifies the position of the second user (step S11), and transmits the position information indicating the specified position of the second user to the meeting support device 100 (step S12). The meeting support device 100 stores the received position information in the user position information 401 of the storage 400 (step S13).

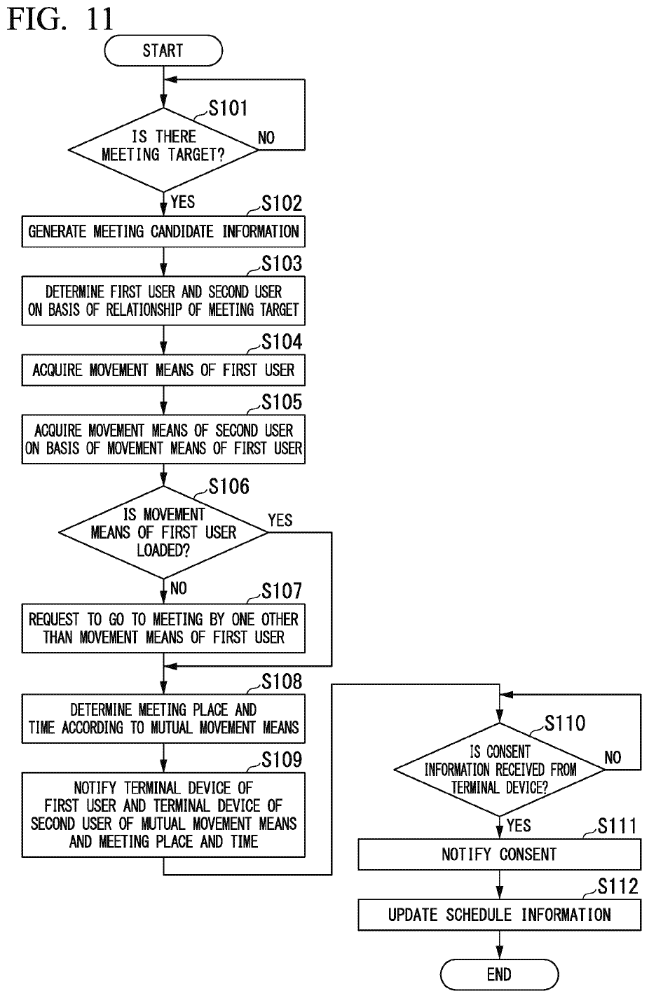

Next, the meeting support device 100 executes a meeting support process (step S14). Note that the meeting support process will be described later with reference to FIG. 11. In the meeting support process, in a case in which the meeting place of the first user and the second user is determined, the meeting support device 100 transmits the information indicating the meeting place, the meeting time, the movement means of the first user and the second user when going to the meeting, and the like to the first terminal device 10 and the second terminal device 20 through the network NW (step S15).

In addition, the first terminal device 10 causes the touch panel 13 to display the meeting notification screen 60 on the basis of the information received from the meeting support device 100. In a case in which the first terminal device 10 receives the consent of the meeting using the touch panel 13 (step S16), the first terminal device 10 transmits the consent information to the meeting support device 100 using the communicator 11 (step S17). Similarly, in a case in which the second terminal device 20 receives the consent of the meeting (step S18), the second terminal device 20 transmits the consent information to the meeting support device 100 (step S19). Therefore, the meeting support device 100 writes the contents of the meeting in the schedule information 402 (step S20), and notifies the user that the meeting party has consented the meeting (step S21).

Next, the process executed in the meeting support device 100 will be described with reference to FIG. 11. FIG. 11 is a flowchart showing the process executed in the meeting support device 100.

Hereinafter, the meeting support process will be described. First, on the basis of the schedule information 402 and the user attribute information 403, the meeting user acquirer 303 determines whether or not there is a meeting user of which a meeting schedule has been determined (step S101). In a case in which it is determined that there is the meeting user, the meeting user acquirer 303 generates the meeting candidate information including the meeting candidate site (step S102). In addition, the meeting user acquirer 303 determines the first user and the second user on the basis of the schedule or the relationship of the meeting user (step S103).

Next, the movement means acquirer 304 acquires the movement means of the first user (step S104). The movement means selector 305 selects the movement means of the second user on the basis of the movement means of the first user acquired by the movement means acquirer 304 (step S105). Here, in a case in which there is no movement means on which the movement means of the first user acquired by the movement means acquirer 304 is able to be loaded among the movement means available to the second user (step S106), the movement means selector 305 generates the information for requesting the first user to go to the meeting place by one other than the movement means possessed by the first user (for example, by walking, by a public movement means, or the like) and outputs the information to the provider 307 (step S107).

Next, the meeting place determiner 306 determines the meeting place and the meeting time according to the mutual movement means on the basis of the movement means of the first user acquired by the movement means acquirer 304 and the movement means of the second user selected by the movement means selector 305 (step S108). In addition, the provider 307 transmits the meeting place and the meeting time determined by the meeting place determiner 306, the movement means of the first user acquired by the movement means acquirer 304, and the movement means of the second user selected by the movement means selector 305 to the first terminal device 10 and the second terminal device 20 (step S109). Up to here is the meeting process shown in FIG. 10.

Next, the provider 307 determines whether or the consent information indicating the consent of the meeting has been received from both of the first terminal device 10 and the second terminal device 20 (step S110). In a case in which it is determined that the consent information has been received from the both, the provider 307 transmits that the meeting has been consented to the first terminal device 10 and the second terminal device 20 (step S111). In addition, the provider 307 outputs the information related to the consented meeting to the data manager 301. The data manager 301 writes the information related to the consented meeting to the schedule information 402 (step S112).

According to the embodiment described above, the movement means acquirer 304 acquires the movement means of the first user, the movement means selector 305 that selects the movement means of the second user on the basis of the movement means of the first user acquired by the movement means acquirer 304, and the provider 307 that provides the movement means of the second user selected by the movement means selector 305 to the second user are provided. Therefore, the second user is able to meet with the first user by the movement means according to the movement means of the first user. Thus, even in a case in which the first user goes to the meeting place by his or her own movement means, the second user is able to load both of the first user and the movement means on his or her own movement means.

In addition, according to the embodiment described above, since it is possible to determine the meeting place according to the movement means of the first user and the movement means of the second user, a smooth getting on a vehicle is possible at the meeting place. For example, in a case in which the first user goes to the meeting place by walking or a train and the second user goes to the meeting place by a car, the meeting support device 100 is able to provide a place such as a rotary of a station or a restaurant with a parking lot where it is possible to park the car as the meeting place. In addition, in a case in which the first user goes to the meeting place on a bicycle and the second user goes to the meeting place by a car that is able to load both of the bicycle and the first user, the meeting support means 100 is able to provide a safe place where a car is parked for loading the bicycle as the meeting place.

In addition, according to the embodiment described above, in a case in which there is no movement means on which the movement means of the first user acquired by the movement means acquirer 304 is able to be loaded among the movement means available to the second user, the provider 307 provides the information for requesting not to go to the meeting by the movement means of the first user to the first user. Therefore, the first user is also able to meet with the second user by the movement means according to the movement means of the second user.

In addition, according to the embodiment described above, the movement means selector 305 acquires the movement means of the second user on the basis of the number of first users and the number of second users who meet. Therefore, the second user is able to go to the meeting place by the movement means according to the number of people who meet.

As described above, although the form for carrying out the present invention has been described using the embodiment, the present invention is not limited at all by such an embodiment, and various modification and substitution are able to be added within the range which does not deviate from the gist of the present invention.

For example, the user who provides the movement means may be the first user, and the user who transfers to the movement means of the first user may be the second user. In this case, the movement means selector 305 determines whether or not the second user (or including the movement means of the second user) is able to be loaded on the movement means of the first user acquired by the movement means acquirer 304. In a case in which both of the second user and the movement means of the second user are not able to be loaded by the movement means of the first user, the movement means selector 305 selects walking or one other than his or her own movement means (for example, a public movement means, other transferal means, or the like) as the movement means of the second user. On the other hand, in a case in which both of the second user and the movement means are able to be loaded by the movement means of the first user acquired by the movement means acquirer 304, the movement means selector 305 selects the movement means capable of getting on the movement means of the first user among the movement means available to the second user as the movement means of the second user.

The movement means selector 305 may select the movement means of the second user on the basis of the movement plan after the meeting. The movement plan includes information such as a destination or a scheduled start time. The movement means selector 305 refers to the schedule information 402, acquires the movement plan after the first user and the second user meet, and selects the movement means according to the destination, the scheduled start time, or the like. For example, in a case in which the destination is a place away from a station, the movement means selector 305 selects a car, and in a case in which there is almost no parking lot at the destination, or in a case in which congestion on a road around an estimated arrival time is predicted and there is a risk of being late at the scheduled start time, the movement means selector 305 may select a train.

The target of the support by the meeting support system 1 also includes a meeting in which the other is not transferred on one movement means after joining. For example, in a case in which it is not possible to select the movement means capable of getting on of both the first user and the movement means of the first user as the movement means of the second user, the movement means selector 305 selects walking or a public movement means as the movement means of the second user. In this case, the first user and the second user may go to the meeting place by the walking or the public movement means.

The meeting user acquirer 303 may acquire user information in order to automatically perform matching of the meeting with respect to a user of which a schedule of the meeting is not clearly determined. For example, the meeting user acquirer 303 may acquire a user corresponding to a predetermined meeting target on the basis of the schedule information 402 or the user attribute information 403. The meeting target is, for example, users who are able to match the schedule and the users who have a predetermined relationship. Note that the present invention is not limited thereto, and the target of the meeting may be users who are able to match the schedule or users who have a predetermined relationship. The predetermined relationship includes, for example, a family member, a relative, a friend, a neighbor, a person in the same area, a person in the same community, a company and a customer providing a movement means, and the like.

The meeting user acquirer 303 may determine the user corresponding to the meeting target as the first user or the second user on the basis of the schedule, the relationship, or the like of the user corresponding to the meeting target.

On the basis of the meeting candidate information input from the meeting user acquirer 303, the movement means selector 305 may acquire the movement means of the second user on the basis of the number of first users and the number of second users corresponding to the meeting target. For example, the movement means selector 305 selects a movement means of which a total number of people of the first user and the second user is equal to or less than a maximum number of passengers among the movement means available to the second user.

Note that, in a case in which there is no movement means on which all of the first user and the second user are able to get among the movement means available to the second user, the movement means selector 305 may instruct the meeting user acquirer 303 to distribute a user who is not able to get on the movement means to a meeting with another user. The meeting user acquirer 303 may acquire a user who is able to meet with the user who is not able to get on the movement means as the user corresponding to the meeting target. Therefore, even in a case in which the second user goes to the meeting place by his or her own movement means, the first user is able to load both of the second user and the movement means on his or her own movement means.

### REFERENCE SIGNS LIST

1 Meeting support system

10 First terminal device

11 Communicator

12 GNSS receiver

13 Touch panel

14 Storage

15 Application executer

20 Second terminal device

30 First electronic apparatus

40 Second electronic apparatus

50 Schedule input screen

51 Calendar

52 Input field

53 Registration button

60 Meeting notification screen

61 Meeting content

62 Consent button

100 Meeting support device

200 Communicator

300 Data processor

301 Data manager

302 Analyzer

303 Meeting user acquirer

304 Movement means acquirer

305 Movement means selector

306 Meeting place determiner

307 Provider

400 storage

401 User position information

402 Schedule information

403 User attribute information

404 Map data

What is claim is:

1. A meeting support system comprising:
a movement means acquirer configured to acquire information related to a movement means of a first user;
a movement means selector configured to select a movement means of a second user who meets with the first user on the basis of the information related to the movement means of the first user acquired by the movement means acquirer; and
a provider configured to provide the movement means of the second user selected by the movement means selector to the second user.

2. The meeting support system according to claim 1, further comprising:
a meeting place determiner configured to determine a meeting place according to each movement means on the basis of the movement means of the first user acquired by the movement means acquirer and the movement means of the second user acquired by the movement means selector.

3. The meeting support system according to claim 1, wherein the movement means selector selects the movement means of the second user on the basis of a movement plan after the first user and the second user meet.

4. The meeting support system according to claim 1, wherein the movement means acquirer estimates the movement means of the first user on the basis of a movement trajectory of position information of the first user.

5. The meeting support system according to claim 1, wherein, in a case in which the first user goes to a meeting place by walking or one other than his or her own movement means, the movement means selector selects a movement means capable of getting on the first user among movement means available to the second user, and in a case in which the first user goes to the meeting place by his or her own movement means, the movement means selector selects a movement capable of getting on both of the first user and the movement means of the first user among the movement means available to the second user.

6. The meeting support system according to claim 1, wherein, in a case in which there is no movement means capable of getting on the movement means of the first user acquired by the movement means acquirer among the movement means available to the second user, the provider provides information for requesting not to go to a meeting by the movement means of the first user to the first user.

7. The meeting support system according to claim 1, wherein, in a case in which the first user goes to a meeting place by the movement means capable of getting on both of the second user and the movement means of the second user, the movement means selector selects the movement means of the second user among the movement means available to the second user, and in a case in which the first user goes to the meeting place by one other than the movement means capable of getting on both of the second user and the movement means of the second user, the movement means selector selects walking or one other than his or her own movement means as the movement means of the second user.

8. The meeting support system according to claim 1, wherein the first user and the second user is one of a user who takes advantage of a movement means or a user who provides the movement means, and
the movement means selector acquires the movement means of the second user on the basis of the number of the first users and the number of the second users who meet.

9. A meeting support method of causing a computer to:
acquire information related to a movement means of a first user;
select a movement means of a second user who meets with the first user on the basis of the acquired information related to the movement means of the first user; and
provide the selected movement means of the second user to the second user.

10. A computer-readable non-transitory storage medium storing a program that causes a computer to:
acquire information related to a movement means of a first user;
select a movement means of a second user who meets with the first user on the basis of the acquired information related to the movement means of the first user; and
provide the selected movement means of the second user to the second user.
